(19) United States
(12) Patent Application Publication
(10) Pub. No.: US 2012/0013575 A1
(43) Pub. Date: Jan. 19, 2012

(54) LIGHT IMAGE CREATION MECHANISM

(76) Inventors: Rory T. Sledge, O Fallon, IL (US); Michael S. Gramelspacher, Greenfield, IL (US); Brian Fuller Weinstock, Clayton, MI (US)

(21) Appl. No.: 12/837,106

(22) Filed: Jul. 15, 2010

(51) Int. Cl. G06F 3/042

(52) U.S. Cl. 345/175

(57) ABSTRACT

An optical image creation mechanism and method is disclosed, which may comprise a screen defining a coordinate system oriented to the screen and having an origin on the screen; a light input signal detection unit, moving with respect to the screen, and which may comprise a light input signal position identifier identifying a light input signal position within the coordinate system; and a light generation unit, moving with respect to the screen, and which may comprise a light initiation mechanism initiating the display of light responsive to the light input signal position within the coordinate system. The light input signal detection unit may comprise a light input signal detector rotating about the origin of the coordinate system of the screen. The light generation unit may comprise a light emitter rotating about the origin of the coordinate system of the screen.

### CROSS REFERENCES

This application is related to U.S. Design patent application Ser. No. ______, filed Jul. 15, 2010 entitled LIGHT IMAGE CREATION MECHANISM, inventors listed as Rory T. Sledge, Michael Gramelspacher, Brian Weinstock and Joseph A Nardozza Jr., attorney docket no. 105432-011500, the disclosure of which is incorporated by reference here in its entirety.

### FIELD

The disclosed subject matter relates to a light image creation mechanism useful for example for electronic art-work creation and storage and electronic game image production and manipulation.

### BACKGROUND

U.S. Pat. No. 7,099,701 issued to Kim, et al. on Aug. 29, 2006, entitled ROTATING LED DISPLAY DEVICE RECEIVING DATA VIA INFRARED TRANSMISSION, discloses a light image display mechanism that includes a rotating LED display device in which a rotating linear array of light emitting elements, such as LED's, are selectively energized and de-energized as the array is rotated at a speed sufficiently fast for the persistence of human vision to detect a displayed text created by the rapidly moving and changing light element array. U.S. Pat. No. 5,791,966 issued to Capps et al. on Aug. 11, 1998, entitled ROTATING TOY WITH ELECTRONIC DISPLAY, discloses a light image display mechanism that includes a rotating toy, such as a top or a yo-yo, that is provided with a linear array of light emitting elements, such as LED's, positioned on the rotating surface and selectively energized and de-energized as the device rotates at a speed sufficient for the persistence of human vision to create a preselected image. In one embodiment the image to be displayed may be selected based on an optical input to an optical device separate from the display array, such as a bar code scanner. Of similar effect in terms of the image display mechanism are U.S. Pat. Nos. 6,037,876, issued to Crouch on Mar. 14, 2000, entitled LIGHTED MESSAGE FAN (light emission linear array on fan blades); 6,325,690, issued to Nelson on Dec. 4, 2001, entitled TOY TOP WITH MESSAGE DISPLAY AND ASSOCIATED METHOD OF INITIATING AND SYNCHRONIZING THE DISPLAY (light emission linear array of LED's on a rotating top); 7,179,149 issued to Chernick et al. on Feb. 20, 2007, entitled SPRING SUPPORTED ILLUMINATED NOVELTY DEVICE WITH SPINNING LIGHT SOURCES (linear array of light emitting devices on a rotating fan blade supported on a flexible arm); and 7,397,387, issued to Suzuki et al. on Jul. 8, 2008, entitled LIGHT SCULPTURE SYSTEM AND METHOD (plurality of differently oriented linear arrays of light emitting elements such as LED's rotated in space). U.S. Pat. No. 6,997,772, issued to Fong on Feb. 14, 2006, entitled INTERACTIVE DEVICE LED DISPLAY, discloses a toy with a stationary flat array of LED's. United States Published Patent Application No. 20070254553, published on Nov. 1, 2007, with Wan as a named inventor, discloses a toy with an internal rotating shaft on which are mounted an array or LED's for illumination in a selected pattern to illuminate openings in the toy.

There remains a need for improvement of the character and content of the image displayed and also the user interface for generating light images, which applicants have provided in embodiments of the disclosed subject matter.

### SUMMARY

An optical image creation mechanism and method is disclosed, which may comprise a screen defining a coordinate system oriented to the screen and having an origin on the screen; a light input signal detection unit, moving with respect to the screen, and which may comprise a light input signal position identifier identifying a light input signal position within the coordinate system; and a light generation unit, moving with respect to the screen, and which may comprise a light initiation mechanism initiating the display of light responsive to the light input signal position within the coordinate system.

The light generation unit may display the light from the light input signal position within the coordinate system to a second light position within the coordinate system. The light input signal detection unit may comprise a light input signal detector rotating about the origin of the coordinate system of the screen. The light generation unit may comprise a light emitter rotating about the origin of the coordinate system of the screen. The method and mechanism disclosed may utilize a controller controlling the light generation unit in response to the light input signal position within the coordinate system according to a stored controller program. The display may be in a selected pattern oriented to the light input signal position within the coordinate system. The controller may control the display responsive to a subsequent light input signal identified by the light input signal detection unit. The light input signal detection unit may comprise one of a plurality of light input signal detector elements positioned on a rotating blade on a first extension of the rotating blade; and the light generation unit may comprise one of a plurality of light generator elements positioned on a second extension of the rotating blade, the first and second extensions may be in different directions.

A method of creating an optical image may comprise providing a screen defining a coordinate system contained within the screen and having an origin; utilizing a light input signal detection unit, moving with respect to the screen, identifying a light input signal position within the coordinate system; and utilizing a light generation unit, moving with respect to the screen, initiating the display of a light responsive to the light input signal position within the coordinate system.

A method of creating and manipulating an optical game image may comprise providing a plurality of game position locations defined within a coordinate system having an origin; utilizing a game position location input signal detection unit, moving with respect to the coordinate system, detecting a first game position location input signal; identifying a first game position location within the coordinate system in response to the detection of the first game position location input signal; and utilizing a light generation unit, moving with respect to the coordinate system, creating a first display of a first game piece at the first game position location. The method may further comprise utilizing the game position location input signal detection unit, moving with respect to the coordinate system, detecting a second game position location input signal; identifying a second game position location within the coordinate system in response to the detection of the second game position location input signal; and changing the display of the game piece at the first game position location to a display of the game piece at the second game position location responsive to the identification of the second game position location input signal. The display of the game piece at the second game position may include a modified orientation within the second game position location from the orientation of the game piece within the first game position location.

A method of creating an optical image may also comprise providing a screen defining a coordinate system contained within the screen and having an origin; utilizing a light generation unit, moving with respect to the screen, displaying a selected display on the screen identifying a display action region on the screen comprising one or more light input signal positions on the screen; utilizing an light input signal detection unit, moving with respect to the screen, identifying a light input signal position within the coordinate system; comparing the identified light input signal position to the light input signal position or positions on the screen defining the display action region; taking action according to whether or not there is a match between the identified light input signal position and a light input signal position within the display action region.

A method of creating an optical image may further comprise providing an image position screen defining a coordinate system contained within the screen and having an origin; detecting a first light input signal; generating a menu image utilizing a stored image database, the first light input signal or a combination of the stored image database and the first light input signal to display an input menu on the screen; utilizing a second light input signal, located by a relationship to the menu image, modifying the optical image.

An optical image creation mechanism may further comprise a coordinate system orientation signal transmitter and a coordinate system orientation signal detector cooperative to provide to the controller a coordinate system orientation signal. Also included may be a mode of operation signal detector rotating about the origin of the coordinate system of the screen and adapted to receive a mode of operation input signal of a type determined by the rotational angular displacement of the mode of operation signal detector when a mode of operation signal is detected.

### BRIEF DESCRIPTION OF THE DRAWINGS

FIG. 1 shows a perspective, partly schematic, view of an image creation mechanism according to aspects of a possible embodiment;

FIG. 2 shows a perspective, partly schematic, view of the image creation mechanism of FIG. 1 with a top cover removed;

FIG. 3 shows a schematic representation of types of displays that may be generated utilizing the image creation mechanism of FIGS. 1 and 2;

FIGS. 4, 4A, 4B, 4C and 4D illustrate schematically mode or function selection screen displays according to aspects of an embodiment on the disclosed subject matter;

FIG. 5 illustrates aspects of a possible input pixel position determination;

FIG. 5A is a detail of the illustration of FIG. 5;

FIG. 6 is a schematic block diagram of a process for determining an input pixel position;

FIG. 7A shows a schematic representation of a top view of a rotating blade according to aspects of an embodiment of the disclosed subject matter;

FIG. 7B shows a schematic representation of a bottom view of a rotating blade according to aspects of an embodiment of the disclosed subject matter;

FIG. 7C shows schematically an alternative arrangement of light emitting elements on the rotating blade to form an image created with an image creation mechanism of the disclosed subject matter;

FIG. 8 is a schematic illustration of a game playing mode of the image creation mechanism of the disclosed subject matter where user input selects a game piece and a game piece location on a game board displayed by or superimposed on the screen of the image creation mechanism and wherein the image creation mechanism displays the game piece at the game piece location;

FIG. 9 is a schematic illustration of a game playing mode of the image creation mechanism of the disclosed subject matter where user input is tested against a game board displayed by or superimposed on the screen of the image creation mechanism and wherein the validity of the input selection position is determined by the controller vis-à-vis the game board;

FIG. 10 is a schematic illustration of a game mode of the image creation mechanism of the disclosed subject matter where user input selects a game piece having an original position on the game board and selects a destination position, which may include an orientation at the destination position, and the controller determines the validity of the change and displays the game piece at the destination position if the move is valid;

FIG. 11 is an illustration of a mode/functionality selection portion of an image creation mechanism according to aspects of an embodiment;

FIG. 12 shows a block diagram illustrating steps in a method according to aspects of an embodiment of the disclosed technology;

FIG. 13 shows a block diagram illustrating steps in a method according to aspects of an embodiment of the disclosed technology; and,

FIG. 14 shows a block diagram illustrating steps in a method according to aspects of an embodiment of the disclosed technology.

### DETAILED DESCRIPTION

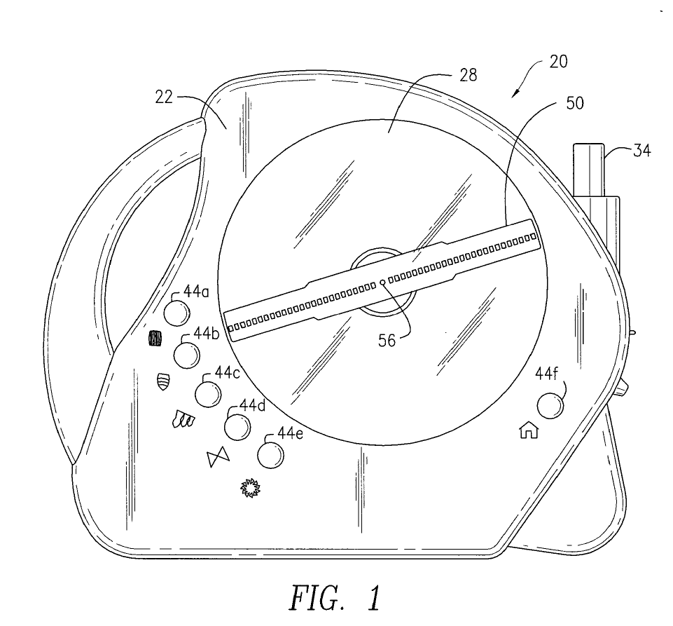

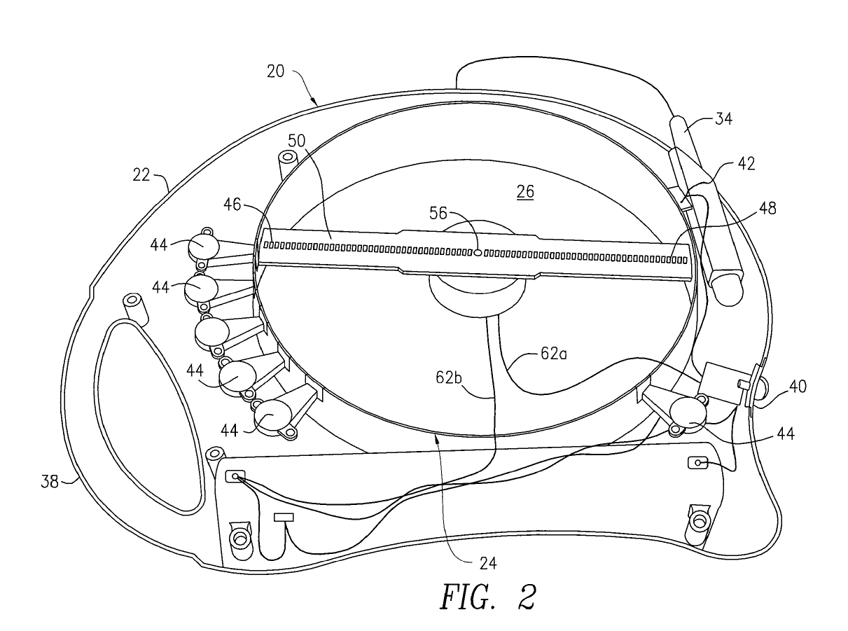

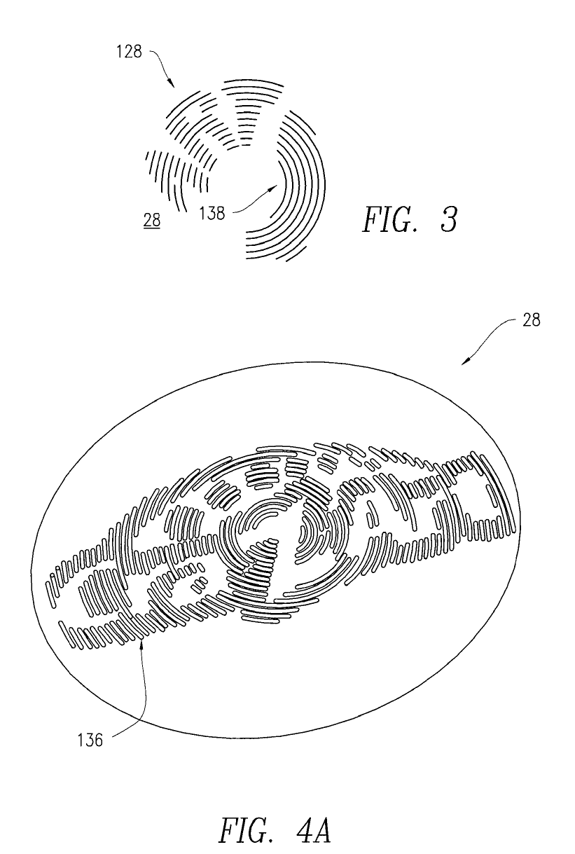

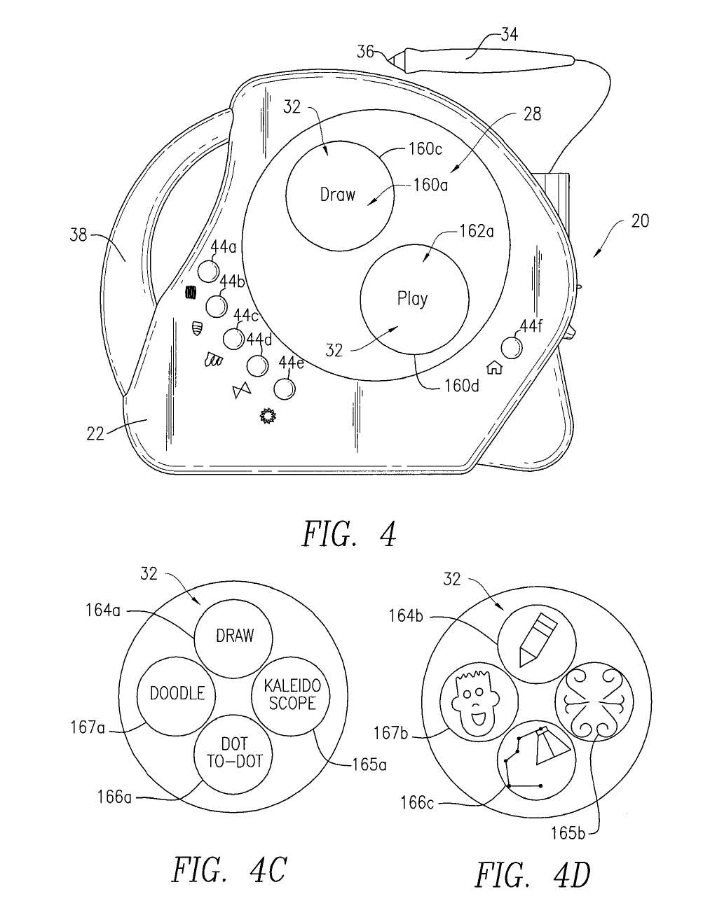

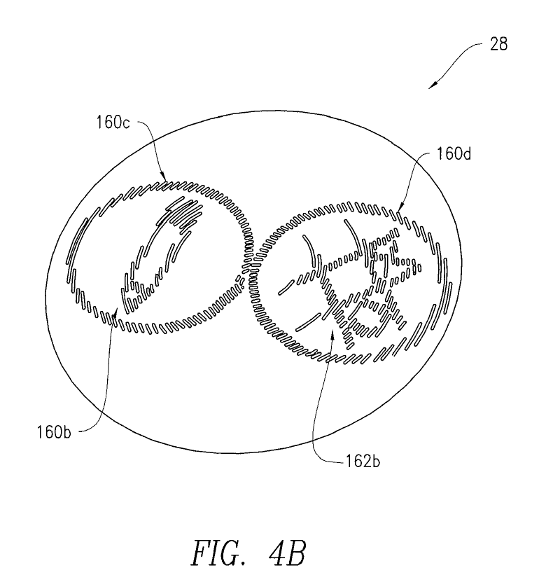

Turning now to FIGS. 1 and 2 there is shown a light image creation mechanism 20 which may be utilized to create light images, including pictures and art, and including with special effects. The image creation mechanism 20 may also be used to play games with light imaging and/or manipulation of game environments, game pieces and game movements, etc. The light image creation mechanism 20 may include a housing 22 with a housing interior 24. The housing interior 24 may include a blade compartment 26 containing a blade 50, discussed in more detail below. The housing 20 may also include a screen 28 which may comprise the portion of the image creation mechanism 20 on which is displayed a created image such as a light display 32 (shown schematically, and by way of example, in FIGS. 3, 4, 4A, 4B, 4C and 4D). The screen 28 may define an image 32 location(s) within the confines of the screen 28 where an image 32 appears, such as is illustrated in FIGS. 3, 4A, 4B, 4C and 4D. The screen 28 may define the display 32 according to, e.g. a coordinate system such as an x-y coordinate system with its origin at the center of the screen 28, corresponding to an extension of the blade 50 rotating motor shaft 56.

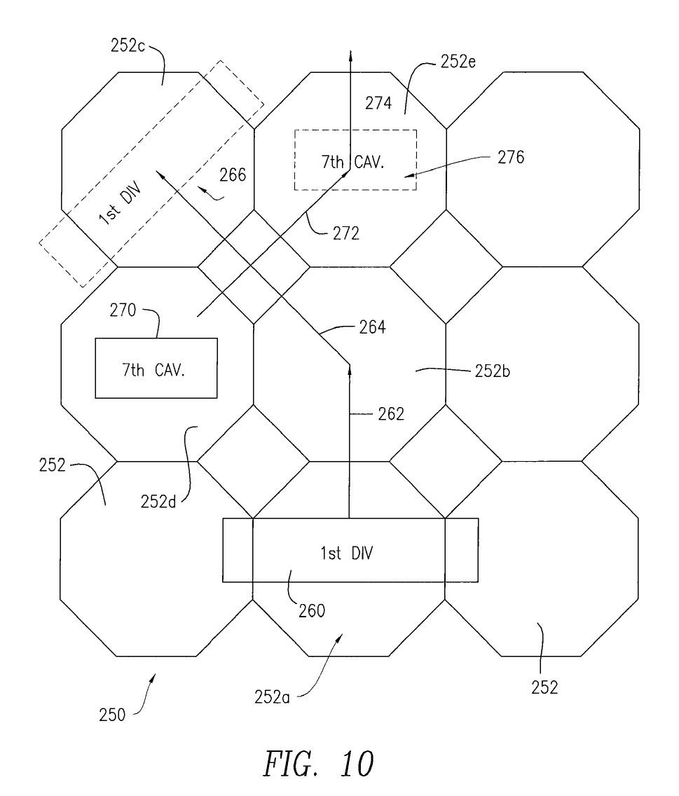

The display 32 on the screen 28 may be of a variety of particular border shapes, such as rectilinear, circular, etc. The display image 32 on the screen 28 may vary from time to time, e.g., to show more detail, such as an inset of a game board illustrating a larger game board area of which the inset forms some part. The display 32 may include a light display image portion generated by the light image creation apparatus 20, and method of operating the light image creation mechanism 20, according to the disclosure of the present application. The display image 32 may initially include only an overlay placed on the screen 28, to which the light image creation mechanism 20 may subsequently add displayed light images. An overlay, an example of which may be seen in FIG. 10, alone or in cooperation with the light generated image(s), such as image(s) 32, produced by the disclosed light image creation mechanism 20, can define the locations within and other features of something being displayed on the screen 28. As an example, the display 32 on the screen 28 could define an input signal location(s) on the screen 28, a game board and locations within the game board, the size, shape and location of elements of a light display art work, such as a drawing produced by the light image creation mechanism 20, and the like.

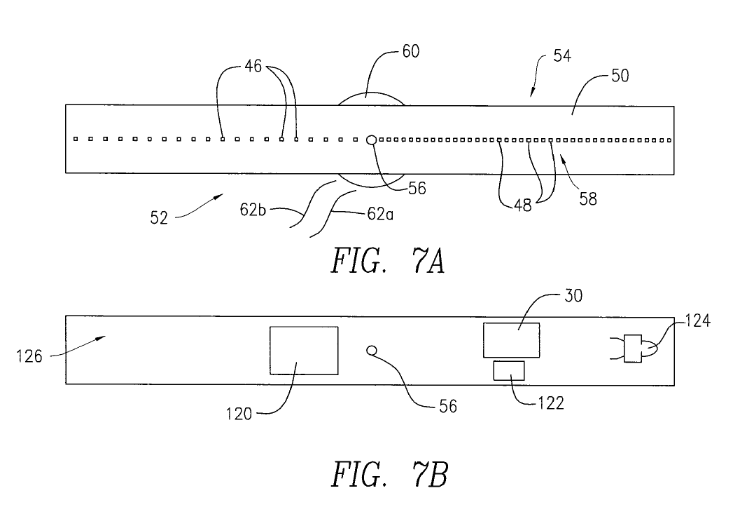

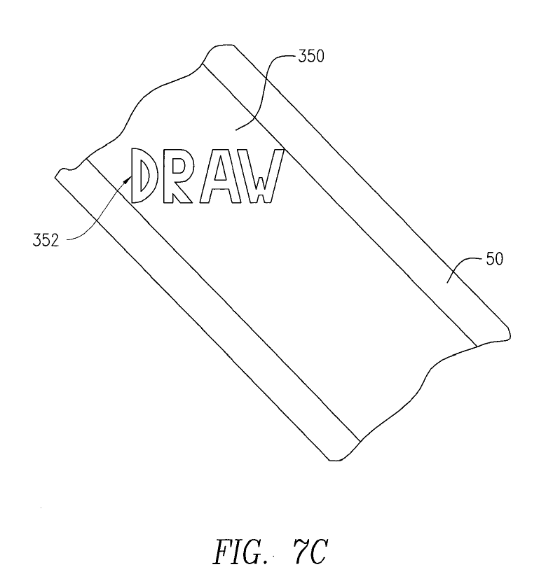

The image creation mechanism 20 may also include, attached to the housing 22 an input device 34, such as a stylus or optical pen, either of which may be used to provide input correlated to an input position on the screen 28. Such input may be then used by a controller 30 (shown in FIG. 7B) of the image creation mechanism 20 to locate an input pixel location. In the case of the controller initiating a light output at the location of the input pixel, as discussed in more detail below, the input pixel location corresponds to a light initiation position and is defined according to the positioning of a light input signal position, received, e.g., from the input device 34 at a given pixel location, i.e., at a selected screen 28 position. In the illustrated example, explained in more detail below, a rotating blade with forty detectable (or at least determinable) input locations and a corresponding forty light emission units, with 256 discrete angular positions there are 256×40 discrete pixel locations for input positions on the coordinate system of the screen and the same for display positions.

The input signal provided by the input device 34 may comprise a variety of possible input signal types subject to being sensed in relation to occurring at or near some location on the screen 28. These could include such as pressure applied to a point on the screen 28, or the presence of some radiation or other electro-magnetic, magnetic or sonic energy. As such, the input device 34 may be tipped with a light source 36 (shown in FIG. 4). The housing 22 may also include a handle 38, an on/off switch 40, an imaging start/stop input selector 44f and a plurality of mode input selectors 44a-e. The imaging start/stop input selector 44f may return the display to the main menu at any time of operation in another mode.

It will be understood that a variety of input signals may be used in cooperation with the screen 28. Touch screen technology may be used such that the input device 34 may comprise a simple pointed stylus. Optical input may be used, such as from a light pen 34, which may utilize a small light 36 giving off visible light or a laser giving off light in a particular portion of the spectrum, visible or infrared (“IR”) or ultraviolet (“UV”). The input signal in turn may be sensed such as by an input signal detector, which in one embodiment may be a plurality of input signal detectors, e.g., photosensitive devices sensitive to light emitted in the given range of the electro-magnetic spectrum, e.g., the input signal detectors 46. The input signal detectors 46 may also be sensitive to various other types of fields, magnetic, electrical, capacitive, etc. and may also detect (such as ultrasound sonic energy, such as ultrasonic vibrations). They may emit light and detect its reflection to simulate touch screen input. LEDs can function in both a detection and emission mode, and, therefore, may be used as both in lieu of a set of detector elements 46 and a separate set of emitter elements 48.

Turning now to FIG. 7A there is shown in more detail a rotating blade 50 according to one exemplary embodiment of the disclosed subject matter. The blade 50 may include an input signal detection left half 52, including photo-transistors 46 and an optical output right half 54, including LEDs 48, on opposing sides of a blade rotational shaft 56. The blade 50 may be rotated on the blade rotational shaft 56 by a blade motor 60 driving the rotational shaft 56 utilizing power supplied through blade motor electrical leads 62a, 62b. The blade 50 may have mounted on the blade top 58, shown in FIG. 7A, on the input signal detection half 52, a plurality of input signal detectors 46, e.g., 20 photo-transistors 46 in a linear array and, on the optical output half 54, a plurality of light emitting elements 48, such as 40 LEDs 48 in a linear array. It will, of course, be recognized that other arrangements are possible, e.g., the linear arrays of detectors 46 and emitters 48 may be on the same extension of the blade 50 from the rotational axis 56

Other electrical, electromechanical and optical elements may be mounted on the blade under belly 126 on the reverse side of the blade top 58, as shown, by way of example only, in FIG. 7B. This may include, an image creation mechanism controller 30, such as a 16 bit microcontroller available from Elan Microelectronics Corp., a memory 120, such as a high speed flash memory, discussed further below, and a serial program storage device 122. A light detector 124, such as an infrared light detector 124 may be positioned at one end of the belly 126 of the blade 50 for sensing IR radiation coming from a positioning or orientation beacon 42 or from the various input selectors 44a-f, as will be discussed in more detail below. It will be understood that positioning/orientation may be accomplished by other forms of transmitters and or other field generators along with suitable detectors, one rotating and one stationary so that the time of the one passing by the other can be used by the controller 30 to determine alignment of the arrays to the coordinate system of the screen and RPM of the rotational element 50. Other well known electrical, electromechanical and optical ways to determine the rotational blade motor shaft 56 orientation at any given time and RPM may also certainly be employed.

The controller 30 may have hard-wired software, firm ware, and may also access some of its operating or application software from the serial program storage device 122 upon being energized.

The blade top 58 and underbelly 126 may comprise printed circuit boards with electrical interconnection, such as data and electrical buses interconnecting the components on the blade 50 noted in the preceding paragraphs. Other components, such as added memory, controller user interface, such as a keyboard, additional computational resources, such as further micro-controllers or micro-processors, such as in a PC, may also be located in or near the housing 22. These may communicate with the controller 30, e.g., through electrical contact established such as through the motor shaft 56, or wirelessly. In addition, it will be understood that the blade 50 may be any rotating shape, such as by way of example, a disc (not shown), allowing for further component population on the top or bottom of the disc.

In a simple form of image display, such as, responsive to the receipt of the input position signal, and the determination of the location of an input pixel, the controller 30 may illuminate a light emitter 48 from the array of light emitters 48 corresponding to the input signal position, i.e., the input pixel location on the screen 28, e.g., each time (or each second or third or fourth time, etc.) such emitter 48 is in the position on the screen 28 defined by the input pixel location. Thus, the screen 28 will display a simple image comprising an illuminated dot at the input pixel location, and human persistence of vision will react to the dot as a steady dot of light at the input pixel location on the screen 28, provided the blade 50 is rotating at a high enough RPM, the requirements for which are well understood in the art.

Of course, if desired, the controller 30 may illuminate the dot less frequently than needed for persistence of vision to react to the light as non-intermittent and the image 32, comprising the noted single dot at the input pixel location on the screen 28, will be an intermittent display of a dot of light at the input pixel location. A further variation could be for the controller 30 to initiate the emission from the designated light emitter 48 and leave it on for some portion of the rotation of the blade 50, for each successive revolution or selected number of revolutions of the blade 50 (such as every other or every third and so forth), thereby creating the simple image of an arc, enough times per unit of time so that visual persistence responds to a solid un-blinking arc. Alternately, the timing of the illuminations of the arc may be reduced per unit of time so that the arc is perceived to blink on and off.

Another simple variation may be for the controller 30 to energize a plurality of light emitters 48 having some selected positional relation to the single light emitter 48 in the example just discussed, and/or do so at differing possible angular displacement positions of the linear array of emitters 48, in order to form as the image 32 a larger dot or a wider arc, etc. The light emitters 48 within the plurality of light emitters 48 in the linear display may be of the same color or of differing colors. For example the emitters could repeat a pattern of yellow, blue, green and red light emitting diodes (LEDs) 48 for ten repetitions with the example of 40 light emitters 48.

It will be understood that a veritable infinity of images 32, forming art work, text or both, along with other possible images discussed in the present application, may be generated in this fashion, e.g., as is illustrated in FIG. 3. FIG. 3 illustrates a possible variation where the controller 30 senses in one case a plurality of input pixel position locations defining the letters 128 “A”, “R” and “T” written on the screen 28 by a user with the input device 34 and the controller 30 broadens out the display around the sensed input pixel positions to form the letters 128 as illustrated. The controller 30 may utilize some form of character recognition software to convert the detected input pixel locations into the letters 128 “A”, “R” and “T” and display preselected representations of those letters 128 or may use the image broadening techniques discussed above to broaden the displayed arcs around the determined input pixel locations determined from the input pixel positions generated by the user moving the input device 34 over the screen 28. In another case, the input pixels can define a path traced by a sweep/brushstroke 138 across the screen 28 by the user, which is simply a drawing and not useable to select, e.g., letters to display. Again, the controller 30 may broaden out the actually displayed image to form the sweep/brush stroke 138 across the screen 28 as illustrated in FIG. 3.

A further variation, responsive to software running on the controller 30, e.g., accessing some stored data, e.g., in the memory 120, could be for the controller 30 to create a preselected image such as image 136 illustrated in FIG. 4A on the screen 28. The image 136 may be orientated with an input pixel location determination. The image 136 could also be the result of the controller 30 creating an image 136, not in response to an input signal, but, rather, upon booting up of the controller 30 when the image creation apparatus 20 is turned on.

As another example, the controller 30 may vary the image in some preselected fashion. This could be, by way of example, to vary the length of the displayed arc over time or vary the colors or both. In order to vary the colors of a given arc, each location on the linear array of emitters 48 would need to display differing colors. This may be done in the simplest form with a linear array of multiple emitters, either of the required number to individually display one of the selected number of colors, or a linear array with each position having, e.g., three primary colors and the selected color being a blend of one or more of the primary colors.

Similarly the generated arc of a display 32 could be duplicated at other positions in the rotation of the blade 50 according to some preselected pattern. This could constitute mirror imaging, such as in a “kaleidoscope” mode. An example of the former is illustrated in FIG. 3 as discussed above involving the broadening out of the letters 128 in response to individual detected input pixel locations. As shown in FIGS. 4, 4B, 4C and 4D in a possible variation of the display 32 the controller 30 may respond to the interaction of the input device 34 with any position on the screen 28 to determine a selected input location defined by a determined input pixel position and display a preselected image on the screen 28 by illuminating selected light emitters 48 during a selected portion(s) of the rotation path of the respective emitter 48 to form a preselected image 32.

The controller 30 may, without reference to an input pixel position, or other input signal, generate an image first on the screen which may comprise, as shown in FIG. 4, a first menu image 160a and a second menu image 162a. The first menu image 160a may be for selection of a “Draw” functionality/mode of operation and the second menu image 162a may be a game functionality/mode selection image “Play”. The controller 30 may alternate the flashing of the first menu selection images 160a, 162a with alternate first menu selection image 160b and alternate second menu image 162b, illustrated in FIG. 4B. As illustrated in FIG. 4B these may comprise graphic menu selection indications, i.e., a crayon FIG. 160b within the menu selection region, e.g., defined by the surrounding circle 160c, and a tic-tac-toe image 162b within a surrounding circle 160d defining a second menu selection region.

The user may then place the input device 34 within one of the menu selection region defining circles 160c, 160d and the controller 30 in response may then display an appropriate sub-menu selection display 32 such as are illustrated schematically in FIGS. 4C and 4D. The sub-menu selection display may comprise, for the “Draw” menu selection 160a, a “Draw” first sub-menu selection image 164a, a “Kaleidoscope” second sub-menu selection member 165a, a third “Dot-to-Dot” sub-menu selection member 166a and a fourth “Doodle” sub-menu member 167a. Again the controller 30 may alternate corresponding graphic sub-menu selection regions 164b, 165b, 166b and 167b, as illustrated in FIG. 4D.

The user may select any of these sub-menu selections by placing the input device 34 within the boundaries of the accompanying selection region-defining surrounding circles to select one of “Draw”, Kaleidoscope”, “Dot-to-Dot” or “Doodle” modes. In “Draw” mode, as an example, an image 32 may be generated on the screen 28 completely by freehand input with the input signal device 34. In “Kaleidoscope” mode the image 32 may be generated by freehand drawing on one portion of the screen 28 and duplicated in mirror image across an axis of the screen 28 defining two halves of the screen 28. In “Doodle” mode an image may be displayed by the controller 30 and, responsive to user input, interactions with the displayed image may be caused, such as filling in blank regions, adding features, etc. In a “Dot-to-Dot” mode an image may be constructed in the form of connecting the dots in a dot diagram. A possible feature for the “Dot-to-Dot” functionality may be, in lieu of numbered or otherwise permanently designated instructions for connecting the dots, the successive dots may be flashed by the controller 30, e.g., after each previous one is selected by the user input signal.

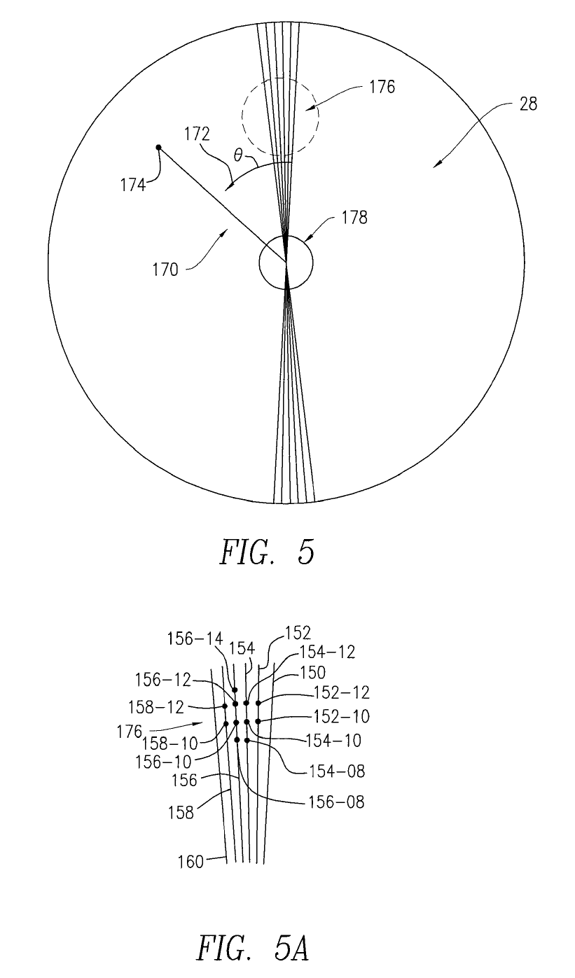

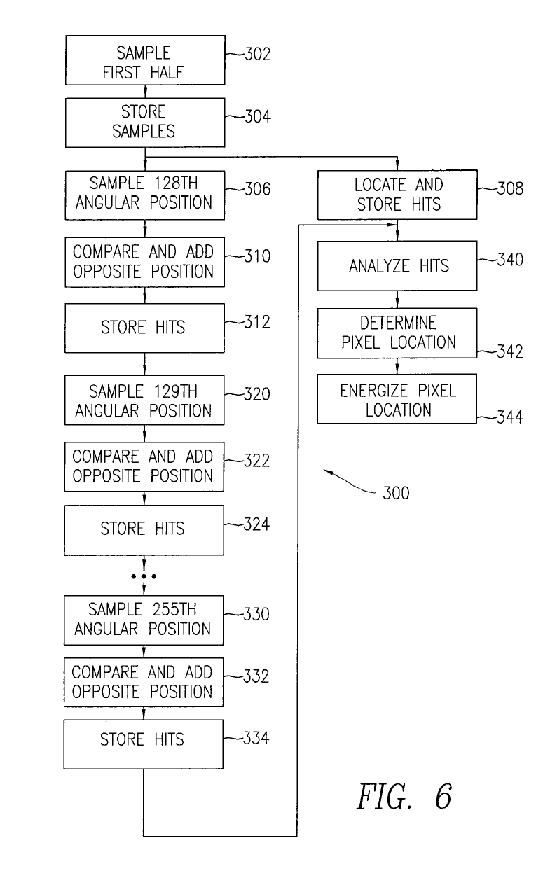

Input signal detection and input pixel location may be better understood by reference to FIGS. 5 and 5A along with FIG. 6. In the simplest of form, the input signal detectors 46 may be arranged in a single linear array. In operation the position of the input device 34 vis-à-vis the screen 28 and whatever display 32 is presented on the screen 28 (overlay, light image or combination), if any, may be determined from the location of the input signal detector(s) 46 that receive and are energized by an input signal from the input signal device 34, at the time of receipt of the input signal from the input signal device 34. Such position is the input pixel location and, where light is to be displayed at or starting from that input pixel position, the input pixel is considered to be the light initiation position point determined by the detection of the light input signal by the detection unit as here explained by way of an example. The light initiation position (input pixel location, as an example) light input signal detection unit, may utilize the rotating linear array of detectors 46.

The detection unit detectors 46, along with software running on the controller 30, detect the location(s) of the longitudinal axis of the array of detectors 46 at the time of detection, e.g., in relation to an angular displacement from a home position (0° displacement from the y coordinate axis of an x-y coordinate system with the y axis vertically aligned to the “top” of the screen 28). It will be understood that “top” as used is an illustrative term and does not limit the image creation mechanism of the present disclosure to any particular orientation to the real world in use. Rather, top herein generally refers to the orientation of the extension of a y axis in a coordinate system for the screen 28, which may or may not align with the top position or the north position in the real world and may continually or frequently change in its lack of orientation to top or north in the real world as the mechanism is utilized and handled and positionally manipulated during use.

At the same time there is detected the position(s) on the array of the detectors 46 sensing the input signal. These factors can be used to determine the position and length of an input position vector and, therefore, also the input pixel position. The direction of an input position vector 170 can have an angle of rotation θ172 from the home position (angular displacement from the home position 150 shown in FIG. 5A). The vector 170 length 174 can also be determined. Together the angle of displacement θ from the home position and the given position on the linear array of detectors 46 define a unique input pixel location relative to the screen 28 and the coordinate system of the screen 28.

As above noted, more than one detector 46 may sense an input signal at any given angle of displacement of the longitudinal axis of the array of detectors 46, and this may occur at more than one angular displacement from the home position 150 of the linear axis of the array of detectors 46. The image creation mechanism 20 controller 30 may utilize software implementing the methods and process described with respect to FIGS. 5, 5A and 6, or other averaging and/or interpolating software, to determine the position of the specific detector 46 and the specific angular displacement θ172 that most closely positions the input pixel to the positioning of the input device 34 at the time of detection of an input signal from the input device 34. As also noted above, the controller 30 may then utilize such input pixel position to react in a variety of ways to the position on the screen 28 of the input signal pixel location/position vis-a-vis the screen 28.

According to aspects of one of a number of possible embodiments, input signal detectors/sensors 46, which may comprise photo-transistors 46, are faced perpendicular to the plane of rotation of the array of detectors 46, i.e., generally perpendicular to the plane of the display 32 on the screen 48. The input signal detectors of the input signal position detection unit may sense an emitted signal of the input device 34. Moving the array of detectors 46 with respect to the screen affords a time/position detection scheme that can place the location of the detector 46 within the screen 28, at the time of stimulation by the input signal from, e.g., the input light pen 34. Thus the position of the external stimulus, the pen 34, at that moment with respect to the screen 28 and whatever display 32 may be on the screen 28 at that moment can be determined.

Assuming that the controller 30 of the image creation mechanism 20 is operating with a memory with address selections within a 256 by X array of memory locations, as illustrated in FIG. 5A, the inputs from the detectors 46 in the array of detectors 46 may be sampled and held at 256 unique locations for each revolution of the blade 50. The corresponding values of the angular displacement θ172 from the home position 150, 360° divided by 256 is illustrated in the detailed view 176 of FIG. 5A.

The home location is identified as home angular position 150, having a 0° of angular rotational displacement from the vertical y axis of an x-y coordinate system defining locations on the screen 28 about the origin 56 through the blade rotation motor shaft 56. The locations of the energized detectors at this 0° angular display position may be stored, such as in a register designated as the 000^{th} memory location. This register may have 21 positions which may comprise a null position and one position for each of, e.g., twenty detectors 46. In the example of FIG. 5A this amounts to no energized detectors 46 and thus no register positions except a null position in the 000^{th} register are populated.

Adjacent home angular position 150 is shown a first angular position 152, 1.41° of angular rotation displacement from the home position 150, and a 001 register memory location. The separation from the home position 150 of 1.41° of angular rotation, is the result of utilizing 256 memory locations, i.e., 360°/256. The photo-transistors 46 in the array are sampled 256 times in each rotation, i.e., the noted 256×21 array, every 1.41° of revolution. It will be understood that other embodiments are possible. One such could be to utilize a 256×20 storage array, with no null position, and simply scan the register positions each time to determine the absence of any bit indications of an energized detector at that given angular displacement location. It will also be understood that circuitry may be employed where the presence of a 0 in a register location is the indication of the respective detector having been energized, rather than the presence of a 1.

Thus, the second displaced angular position 154, is at 2.82° of angular rotation from the home position 150, and stored in a memory register location 002. In like manner there are a third angular displacement position 156, 4.23° of angular rotation displacement from the home position 150, a 003 memory location, a fourth angular position 158, 6.44° of angular rotation displacement, a 004 memory location and a fifth angular position 160, 7.65° of angular rotation displacement, and a 005 memory location. Each of these are shown in the detailed view of FIG. 5A.

According to aspects of the disclosed subject matter, the details of which are discussed below, in regard to FIG. 6, the controller 30 of the image creation mechanism 20 may sample all of the memory locations in the first half of rotation, as an example 0°-178.59° of rotation, and store the indications of which photo-transistors were illuminated at each angular displacement location in a respective register 000-127 and then do sampling and processing as the blade 50 sweeps the linear array of detectors 46 through a second half of rotation, 180°-358.59° (it being understood that 0° and 360° overly each other), i.e., 128-255 designated angular positions separated also by 1.41° of angular rotation and memory registers 128-255. The indications of the photo-transistors that are energized at each location are indicated such as by a bit or bits contained in the photo-transistor register, from 0-20, assuming the 21^{st} position is the null position, or if no null position is used, for the respective memory location 128-255.

In the enlargement of FIG. 5A there is illustrated, as an example, a pattern of energized photo-transistors 46 detected as being energized (having sensed light or other radiation, or field from an input device 34), comprising the photo-transistors 46 in the 10^{th} and 12^{th} positions in the array of photo-transistors 46 positioned on the blade 50 in the rotational position designated as 152 in FIG. 5A, i.e., photo-transistor 152-10 and photo-transistor 152-12. Similarly the photo-transistors in the 8^{th}, 10^{th} and 12^{th} positions in the array of light detectors 46 on the blade 50 when the blade 50 is in the angular position designated as 154 in FIG. 5A are designated as photo-transistor 154-08, photo-transistor 154-10 and photo-transistor 154-12. The light detectors 46 on the blade 50 indicated as energized in 8^{th}, 10^{th}, 12^{th} and 14^{th} positions along the array of detectors 46 when the blade 50 is in the angular position designated as 156 in FIG. 5A are designated to be photo-transistor 156-08, photo-transistor 156-10, photo-transistor 156-12 and photo-transistor 156-14. Also shown to have been energized are the photo-transistors in the 10^{th} and 12^{th} positions along the blade array 46 in the angular position designated as 158 in FIG. 5A, photo-transistor 158-10 and photo-transistor 158-12. There are no photo-transistors indicated to be energized in the angular position designated as 160 in FIG. 5A.

It will be understood that each of the energized photo-transistors 46 detected to be energized as the blade 50 swings through the designated angular displacement positions 150-160 illustrated in FIG. 5A may be stored in a 256×21 or 256×20 memory array according to the orientation of the angular positions 150-160 with respect to the home location 150 and its register 000. As illustrated in FIGS. 5 and 5A, the angular positions for the designated positions 150-160 correspond to the home register 000, and five adjacent registers 001, 002, 003, 004 and 005. It can be seen that none of the bit locations in register 000 would contain a bit except for the null bit, if used, i.e., there is no stored indication of any energized photo-transistor at the home position 150. The bits 10 and 12 in register 001 would be populated with ones or zeros while the other positions in that register designated 001 would have zeros or ones, respectively. In the same fashion the 8^{th}, 10^{th} and 12^{th} locations in register 002, the 8^{th}, 10^{th}, 12^{th} and 14^{th} positions in register 003, the 10^{th} and 12^{th} locations in register 004 and none of the locations in register 005, except the null location 21, if used, would be populated.

These recorded and stored records of the photo-transistors that detected an input signal, such as light, on the passing of the blade 50 under a portion of the screen 28 that was touched, illuminated or otherwise interacted with by whatever form of input device 34 is utilized, can be conveniently processed to select an input pixel position. The input pixel position vis-à-vis the screen and/or displays on the screen can then be utilized as noted above.

In one simple-to-execute and computationally non-complex way to select the respective input pixel location, the controller 30 may access serially all of the registers 000-255 and determine if the null position is populated, and if not what positions are populated, or alternatively, e.g., if any positions are populated, where a null position is not designated or used. This first angular position register where a register location indicating a detector position(s) is populated can be considered a start register. In the illustration of FIG. 5A this would be register 001 and the 10^{th} and 12^{th} positions are indicated as populated. The next adjacent register 002 is accessed and read and it is discovered to have positions 8, 10 and 12 populated. Similarly the next register 003 is accessed and read and found to have the 8^{th}, 10^{th}, 12^{th} and 14^{th} positions populated. Thereafter the register 004 is accessed and read and found to have positions 10 and 12 populated and the next adjacent register 005 is found to have the null position populated, or alternatively no positions populated.

The controller 30 may then consider the register 001 as the start register and 004 as the stop register, the last register after the start register 001 to have positions other than the null position, if used, populated. The controller 30 may then select the register between the start register 001 and stop register 004 to have the most positions populated, e.g., by using a simple compare function algorithm on the intermediate registers 001, 002, 003 and 004 between the start and stop registers 000 and 005, in order to determine the one representing in binary notation the largest number. That register is then selected as the input pixel angular position location register and the middle photo-transistor 46 in the linear array at that indicated angular position can then be selected as the input pixel itself. If there are an even number, as is illustrated in FIG. 5A, then the input pixel position may be selected to be between the middle two, i.e., between the 10^{th} and 12^{th} positions. Thus the input pixel position is 11, at the angular displacement corresponding to register 003.

The controller 30, as an example, can illuminate the 11^{th} LED in the array of light emitters 48 when the blade is at the angular displacement from the home position 0° corresponding to register 003 on the next pass of the blade 50 under the angular displacement position indicated by register 003. This can be simply done by loading into an output register corresponding to the respective one of the 256 input registers (also output register 003) a bit at the 11^{th} position. Thus, by way of example, when the blade 50 is in the angular displacement of the light emitters 48 corresponding to the register 003, the bit in the 11^{th} position in the register 003 is used to cause the LED in the 11^{th} position in the linear array to be energized and emit light.

FIG. 6 illustrates by way of example a sampling method and process 300 that the controller 30 of the image creation mechanism 20 may utilize. In carrying out the process 300 the controller 30 may sample the first half of the pixel positions from the home angular displacement position 150 to the angular displacement position corresponding to 178.59° angular of displacement from the home position 150. In the example discussed above, this would comprise reading and sampling the 20 photo-transistor 46 positions along the linear array 46 at each of the angular displacement locations starting from the home position 150 and loading registers 000-127 accordingly. Any location in which photo-transistors 46 are indicated to have sensed the input signal, at the location assigned to a given register, are populated for that given register.

In the example noted above the appropriate positions in the registers 001, 002, 003 and 004 would be populated. Since this is in the first half of the sweep of the half of the blade 50 carrying the light detectors 46, the processing by the controller 30 to determine the input pixel location for the position of the input device 34 at the time of input, as discussed above, can occur during the second half of that same rotation. The appropriate light emitter 48, such as the appropriate LED, as noted above, can be energized when the blade 50 is in the appropriate angular displacement location from the home position 150, the display pixel location, corresponding to the input pixel location.

Of course, as noted in more detail in this application, the controller 30 of the image creation mechanism 20 of the disclosed subject matter may perform many more functions than simply illuminating the appropriate LED at the appropriate time in the rotation of the blade 50, in order to display using an output pixel(s). These other functions may take information from the location of the input pixel position, such as in relation to a display being generated by the controller 30 on the screen 28, may be oriented to the input pixel location and the like, as explained in more detail elsewhere in the present application.

As illustrated in FIG. 6, a method and process 300 developed by applicants may be utilized to assist in correcting errors in positioning the input pixel location especially where the input pixel is located at a position close to the origin 56 such as within the circle designated as 78 in FIG. 5. Such error may also occur to some degree when the input pixel location is located near the home angular displacement position 150 or at the opposite position at the end of the first half of rotation. The process and method 300 for determining an input pixel location may sample the first half of the screen corresponding to the registers 000-127 as noted above and populate the appropriate positions in the appropriate registers in a sample first half step 302. These results may be stored in the corresponding registers in the array of memory registers in a store samples step 304, as discussed above.

Thereafter, the controller steps through the accessing of each of the remaining registers 128-255, such as sampling the 128^{th} register in a sampling the 128^{th} angular position location step 306, sampling the 129^{th} register in a sampling the 129^{th} angular position step 320 through sampling the 255^{th} register in a sampling the 255^{th} angular position location step 330. After each of these register sampling steps, such as 306, 320 and 330, there is conducted by the controller 30 a compare and add opposite position step 310, 322 and 332 respectively. In the compare and add opposite position steps 310, 322 and 332, the controller 30 determines if there are any populated positions in a given register, such as register 128 in step 306. If so, the opposing register, in this case register 000 is sampled to determine if any bit locations are populated except for the null position.

This may be done conveniently by reading the null position 21 in register 000 and, if not populated, then sampling and holding the remaining bit positions in register 000. Alternatively the stored register positions may all be scanned to determine if any are populated. If there are any positions other than the null position populated in register 000, then the total is concatenated with or added to the number found in the 128^{th} register, designated register 128, in the example under discussion. It can be seen that the populating of registers other than the null position in an opposite register in the first half of the sweep of the blade 50 will mostly occur only where the input pixel position is close to the origin 56.

The controller may also be programmed to perform this concatenation operation when the populated positions in the register for the respective angular displacement in the second half of the blade 50 rotation are within a certain number of locations, such as 4 or 5, from the center position of the blade 50. Otherwise, determination of energized detector elements further away from the center is likely part of a cluster not located in the problematic area near the origin. Similar operations may be done for angular displacements close to the home location and the 180° from home location, where clusters may be identified in angular displacement locations on either side of these transition places. Thus, e.g., for clusters identified in the first few angular displacements after the one stored in register 128, instead of looking at the reflected position, i.e., 000, then registers for the positions just preceding, i.e., as an example, 125-127 may be examined and concatenated with the populated registers above 127.

The detection of input signal response for the registers 128-255 may be processed as note above in regard to FIG. 5A except that the total number of hits in any opposite registers are concatenated to the total found in the register from register 128 to register 255. This may be done in the analyze the hits step 340. The controller 30 can then determine the input pixel location in step 342, also as discussed above, and, thereafter, as an example, the appropriate light emitter 48 can be energized corresponding to the input pixel location in step 344, e.g., as discussed above, by loading a bit into an output register, part of a 256×40 storage array at the appropriate bit location in the appropriate one of the 256 output registers.

FIG. 7C illustrates by way of example a variation for the blade 50. Replacing the linear array of light emitters 48 may be a light emitter 350 with much higher resolution than a linear array of photo emitters 48. For example a sheet 350 of thin film transistors may be laid out on the blade 50. In such an embodiment, the controller 30 may energize photo-emitting transistors, such as laser-emitting transistors, within the sheet 350 to create the display “DRAW” when the blade is in a selected location vis-à-vis the screen 28. It will be appreciated that this apparatus and method of operation may give the display 32 generated much higher resolution.

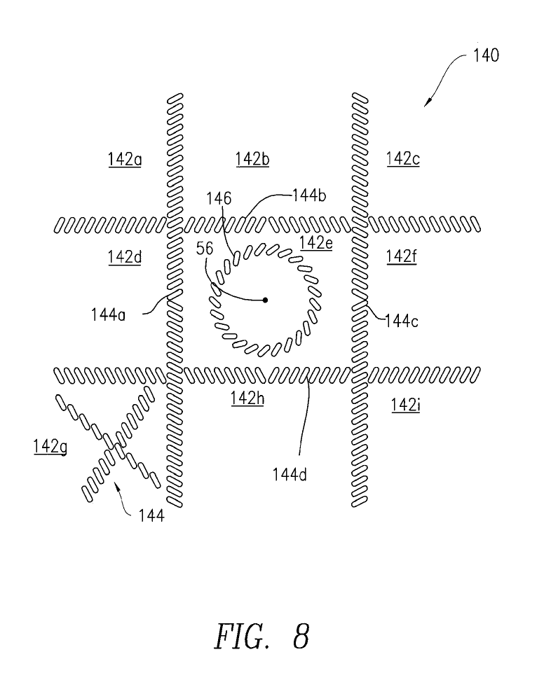

Turning now to FIG. 8 there is illustrated by way of example a simple game that may be played utilizing the image creation mechanism 20 according to the disclosed subject matter. FIG. 8 is a schematic illustration of a game playing mode of the image creation mechanism 20 of the disclosed subject matter where user input selects a game piece and a game piece location on a game board displayed by and/or superimposed on the screen 28 of the image creation mechanism 20 and wherein the image creation mechanism 20 displays the game piece at the game piece location.

The familiar game tic-tac-toe can have the game board 140. The game board 140 may be oriented with respect to the origin 56 and the coordinate system of the screen 48 relative to the origin 56. The game board display 140 may have a plurality of game play location regions 142 a-i, which may be defined by a plurality of respective game play location region boundaries 144 a-d, some of which may be displayed and some not. The game board 140 with the game location regions 142 a-i and respective game location region boundaries 144 a-d may be an image created by the controller 30 on the screen 28 utilizing the light emitters as described above as illustrated schematically in FIG. 8. The game board 140 may have stored coordinates defining the respective game location region boundaries 144 a-d for each game play location region 142a-i, again, not all being displayed in the illustrated game board 140 of FIG. 8. The receipt by the controller 30 of an input signal and identification of an input pixel location within a respective set of boundaries 144a-d of a game location region 142a-i can cause the controller 30 to display the player's “X” game piece 144 or “O” game piece 146 in the selected game play location region 142 a-i. The game board 140 may be in the form of an overlay placed on the screen 28 and oriented to the coordinate system of the screen 28.

The controller 30 may utilize tic-tac-toe game playing software to determine a winner or that the game ended in a draw, or the users may so determine during game play. The controller 30 may employ means to distinguish between players, such as simply determining that alternate moves are respectively accorded to each of the two players. In addition, the photosensitive detector 46 may be sensitive to light in different bands of the spectrum and emit a different signal to the controller 30 depending upon, e.g., whether the input signal light is red or green, with red indicating input from a first player and green indicating input from a second player.

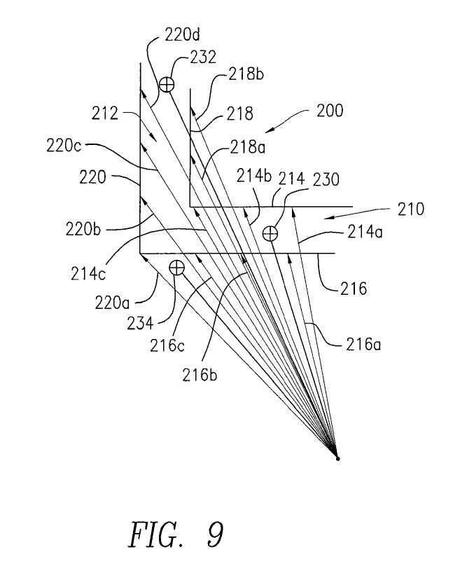

FIG. 9 illustrates schematically how the image creation mechanism 20 of the present disclosure may be utilized to play a different more complex game having a more complex set of rules for play than the illustrated tic-tac-toe game discussed above. FIG. 9 shows partly schematically another illustration of a game playing mode of the image creation mechanism 20 of the disclosed subject matter where user input may be tested against locations on a game board displayed by or superimposed on the screen 28 of the image creation mechanism 20 and also wherein the validity of the input selection position is determined by the controller 30 vis-à-vis the game board.

In this illustration the game board 200 is for a maze game, a portion of which is shown by way of example in FIG. 9. The maze game board 200 may have a maze game horizontal passage 210 and a maze game vertical passage 212. The horizontal passage may have a horizontal passage upper wall 214 and a horizontal passage lower wall 216. The maze game board 200 may have a vertical passage right wall 218 and a vertical passage left wall 220. The boundaries of the game board 200 horizontal passage 210 may be defined by a plurality of horizontal passage 210 upper wall defining position vectors 214a, 214b and 214c each defined, e.g., by the position on the screen 48 of a unique position-vector-defining pixel location The game board 200 may have a plurality of horizontal passage 210 lower wall defining position vectors 216a, 216b, 216c and 220a, each also having a unique position-vector-defining pixel position. These position-vector-defining pixels for the position vectors 214a-c, 216a-c and 220a can originate from the origin 56 of the coordinate system of the screen 28. Similarly, the boundaries of the vertical passage 212 may be defined by vertical passage 212 right wall position-vector-defining pixels, defining position vectors 214c, 218a and 218b and vertical passage 212 left wall defining position-vector-defining pixels, defining the position vectors 220a, 220b, 220c and 220d.

During play of the maze game the controller 30 may respond to input from a game position input defined by the location on the screen 28 of the input pixel, such as for an in bounds position 230, by determining that the input pixel vector for the in bounds position 230 is contained within the boundaries of the horizontal passage 210. Similarly the controller 30, in response to receipt of another input position signal defining a second input pixel position, may determine that the input pixel for an in bounds position 232 is at a position within the vertical passage 212, and so defines a valid entry. The input of two position points 232, 234 could be used by the controller 30 to modify the image 200 to shown a game play path (not shown) through the horizontal passage 210 and the vertical passage 212 that connect the input positions 230 and 232.

By contrast, the controller 30 may determine that an input pixel from a game player input at point 234 on the game board 200 is in an out-of-bounds position vis-à-vis the passages 210, 212. Depending on the rules of play of the game, this error in position point entry due to the out of bounds input signal detection point for the respective input pixel could cause the game to terminate, or reduce points to the player, etc. all of which may be taken under the control of the controller 30.

In a still more complex form of game which may be played utilizing the image creation mechanism 20 of the disclosed subject matter may be an action game, the playing of which may be understood in relation to FIG. 10. FIG. 10 is an illustration of a game mode of the image creation mechanism 20 of the disclosed subject matter where user input selects a game piece having an original position on the game board and selects a destination position, which may include an orientation at the destination position, and the controller 30 determines the validity of the change of position/orientation from the original position/orientation of the game-playing piece and displays the game-playing piece at the destination position/orientation if the move is valid. As illustrated in FIG. 10 the image creation mechanism may utilize an action game board display 250, which, again, may be generated using the light emitters 48 of the image creation mechanism 20 or be in the form of an overlay or both. In the particular game utilized to illustrate this aspect of game play with the image creation mechanism 20 of the present disclosure, the game may be a recreation of a Civil War battle.

As illustrated schematically in FIG. 10 a game board 250 may be in the form of a plurality of position and direction game board location spaces 252, which are illustrated as being octagonal to enable the definition and execution of complex game piece 260 movements. In this case each “move” may be carried out over a selected course of time in the replayed battle, such as an hour. In such case a game piece 260, 270, according to the rules of the game, may be allowed movements tied to characteristics of the unit represented by the game piece 260, 270.

As illustrated game pieces 260 and 270, respectively, represent an infantry division and a cavalry brigade. The movements allowed may be to execute no more than a fixed number of pivoting and forward motion movements constituting the one game-play move. For an infantry division game-piece 260, this may be, as an example, 3 movements. For a smaller and more agile cavalry brigade game piece 270 this may be five movements.

Thus, in a given move for the player controlling the game pieces 260 and 270, the former game piece 260 may move from a starting location space 252a to an adjacent intermediate location space 252b along a movement vector 262 in the direction in which the game-piece 260 was facing, then pivot once to align with a rotation and movement vector 264 pointing to a final location space 252c, as a second movement, and then move along the rotation and movement vector 264 to the final game-piece position 266 in the final game location space facing the direction as shown in phantom in FIG. 10.

Also as illustrated by way of example in FIG. 10 a game piece 270 representing a cavalry brigade may be allotted 5 movements within a given game-play move. Thus the game piece 270 may start from a starting-location space 252d pivot once and move to an adjacent intermediate location space 252e along a movement vector 272 and pivot once within the space 252e to the position as shown in phantom in FIG. 10, utilizing the same three movements allotted to the piece 260 and then move into the adjacent space (not shown) along a rotation and movement vector 274 and then pivot once to wind up on the right flank of the piece 260 representing the infantry division and facing in the same direction in that final space (not shown) as the piece 260 is facing, utilizing the five movements allotted for the given move.

It will be understood that the image creation mechanism 20 according to the disclosed subject matter may greatly facilitate the playing of the game just described. As an example, for the movement of a game piece, such as game piece 260, the controller 30 of the image creation mechanism 20 may sense an input from the input device 34 defining an input pixel within the boundaries of the game-position-location space 252a. The controller 30 may determine that there is currently a playing piece 260 at that location and having a directional orientation aligned to the movement vector 262. The game player may then put the input device 34 in the space 252c to which the piece 270 is desired to be moved and then indicate a desired orientation for the piece 260 in location space 252c, e.g., by drawing an arrow generally aligned to the movement orientation direction vector 264. The controller 30 may then determine by the location of the input pixel for the destination space selection, space 252c, and from the orientation of the arrow location designation input pixels, determine the final space and orientation desired by the game player. The controller 30 may then also determine if such a move can be accomplished within the allotted movements for the given game piece 260 and if so, remove the illumination of the game piece as shown in FIG. 10 in the initial location space 252a and illuminate the game piece 260 in the position shown in phantom in FIG. 10 in the position space 252c.

The game map 250 as illustrated in FIG. 10 could be an enlarged inset from a larger and less detailed game map (not shown) which may be accessed and displayed on the screen 28 when a location on the map (not shown) is selected by the position of an input signal relative to the displayed larger map.

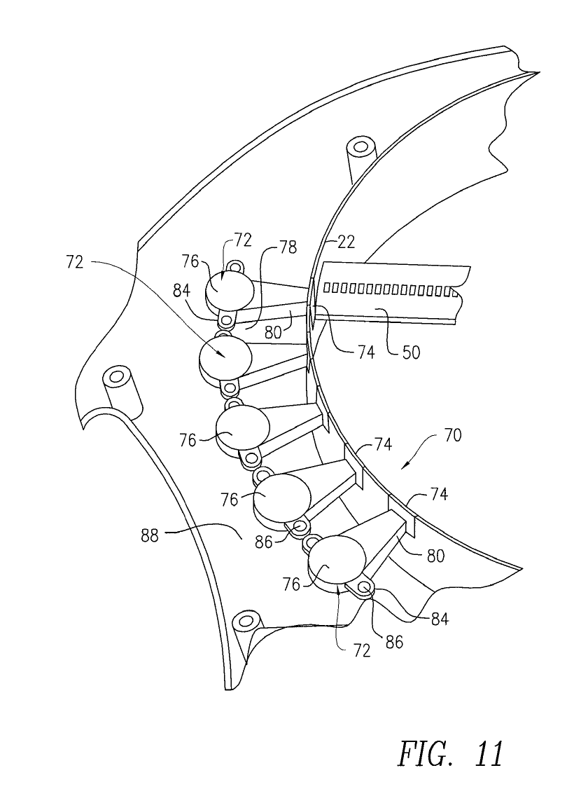

According to other aspects of an embodiment of the disclosed subject matter the image creation mechanism 20 may have other means for providing input to the controller apart from input pixels related to the screen. A mode/function selection facility may be implemented through the use of a mode/function selection section 70 contained within the housing 22 as shown in FIG. 11. The function/mode selection section 70 may comprise a plurality of function/mode selector deflector lens assemblies 72. Each assembly 72 may have an input lens 76, a deflector lens 74 and an internal reflector side wall 78 intermediate the two on an optical path. The deflector lens 74 may be at the end of a tapered body 80. The assembly 72 may have a mounting protrusion (not shown) extending from a frame of the deflector lens 74 and a pair of pin openings 84 for receiving a respective mounting pin 86 extending from a mounting stanchion 88 for the respective assembly 72.

The mode/function selection section 70 deflector lens assemblies 72 are each aligned to a radial axis of the blade 50 extending from the center 56 of the screen 28 coordinate system for an image creation mechanism 20 with a rotating blade 50 movement mechanism for moving the detectors 46 and emitters 48 in relation to the screen 28. Each is positioned at a selected angular displacement from the home position 150 in the coordinate system of the screen 28 image creation mechanism 20. When light is detected emitting from a respective input lens 76 at a registered angular displacement, e.g., by a light detector 124 as the end of the blade 50 passes that location, the controller 30 receives an input to change to the function/mode associated with the location of the given function/mode selection assembly 72.

Light from the input device 34, such as from a light pen, may be directed by the user into a respective deflector lens 74 for the respective function/mode selection deflector lens assembly 72. The light may then be reflected at the internal reflector side wall 78 and exit the input lens 76 to be detected by the light detector 124.

By way of example, there may be five function/mode selectors 72. A first one may be a “Clear” mode selector having a selector lens 74 which when passing light to the light detector 124 due to the user placing the input device 34 light source at the respective input lens 76 causes the controller 30 to erase the screen 28 in order to restart or load an image or go to some other function within a game, etc. Another may be an “Erase” mode selector having a selector lens assembly 72, which when emitting light due to the user placing the input device 34 at the respective input lens 76 causes the controller 30 to turn the input device 34 into an eraser. As such., e.g., locations on the screen that are provided with an input signal by the input device 34 erase the displayed image at the location. Yet another function/mode, “Brush Size” mode, may similarly be selected and cause the controller 30 to display a screen on which the user can select different brush sizes, from smallest to largest, e.g., with four possible selections. With the brush selected “brush strokes” of the image 32 drawn on the screen 28 will widen or narrow according to the changed brush size selected and the size of the one used before. An “Invert” function/mode selector may cause the controller 30 to change black displayed areas to color and color displayed areas to black and/or to wink back and forth between the two to display an image and its negative. An “Animate” function/mode selector may cause the controller 10 to animate the displayed image, such as by stepping the display through a sequence of displayed images so as to give a figure being displayed a form of animate motion.

A start/stop input light source 44f may similarly may be used to cause the controller 30 to start or stop image displaying after the image creation mechanism 20 is turned on using the on-off switch 40 or to return to the main menu from any other mode.

The light detector 124 may also be utilized to determine the positions of the detectors 46 and emitters 48 at any given time in relation to the screen 28 and the coordinate system of the screen 28. A positioning light source 42, such as an infrared light emitter 42 may be positioned within the housing 22 at a location around the wall of the blade compartment 24. The light detector 124 may also be utilized to detect when the blade passes the light emitter 42. Detection of the blade 50 and the light detector 124 passing the light source 42 can allow the controller 20 to orient the position of the blade 50 with respect to the screen 28 and the screen coordinate system at any given time, according to the orientation of the light source 186 to the home position 150, if not located at the home position 150 itself. In addition, successive passages through the infrared light source 186 by the detector 124 gives the RPM for the blade 50. Therefore, the controller 30 can calculate position vectors to all locations on the screen 28, input pixel locations, etc. with greater accuracy. This can account for changes in such as RPM due environmental conditions, battery end of life, frictional wear and tear, etc. As noted above there are many other ways to determine blade location in time and RPM.

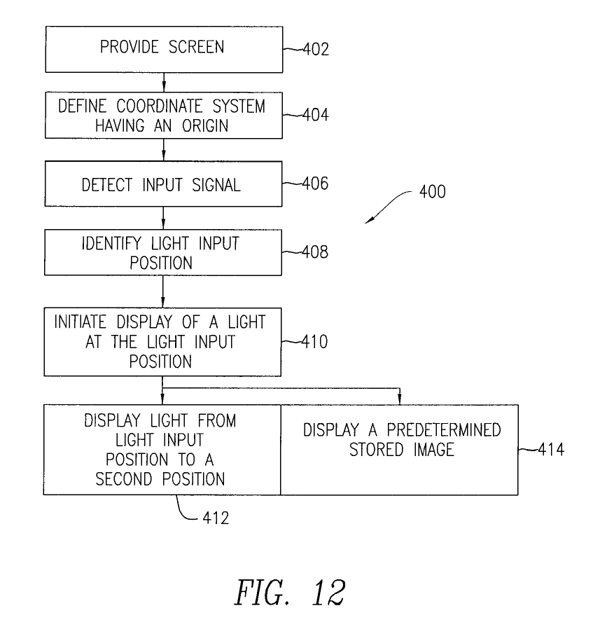

Turning now to FIG. 12 there is shown a flow diagram for a method 400 of utilizing an image creation mechanism 20 according to aspects of an embodiment of the disclosed subject matter to create an optical image. The method 400 may comprise providing a screen defining a coordinate system contained within the screen and having an origin, as is discussed above with regard to a number of embodiments, and is illustrated in FIG. 12 as a Provide Screen block 402 followed by a Define Coordinate System Having an Origin block 402.

The method 400 can then take the step of utilizing a light input signal detection unit, moving with respect to the screen, identifying a light input signal position within the coordinate system, represented by the Detect Input Signal and Identify Light Initiation Position Point steps in blocks 406 and 408. The method 400 may then include the steps of utilizing a light generation unit, moving with respect to the screen, initiating the display of a light at the light initiation position point corresponding to the light input signal position or otherwise referred to as the light input pixel corresponding to the light output display pixel, within the coordinate system, which is represented by the Initiate Display of a Light At the Light Initiation Position Point in block 410.

This very basic method 400 of utilizing the light image creation mechanism of the present application may alternately be followed by a step of utilizing the light generation unit, displaying the light from the light input signal position to a second position within the coordinate system defined by the movement of the light generation unit, represented by block 412 in FIG. 12 or by a step of displaying a predetermined stored image selected based upon an identified light input signal position, which is represented by the Display Predetermined Image block 414.

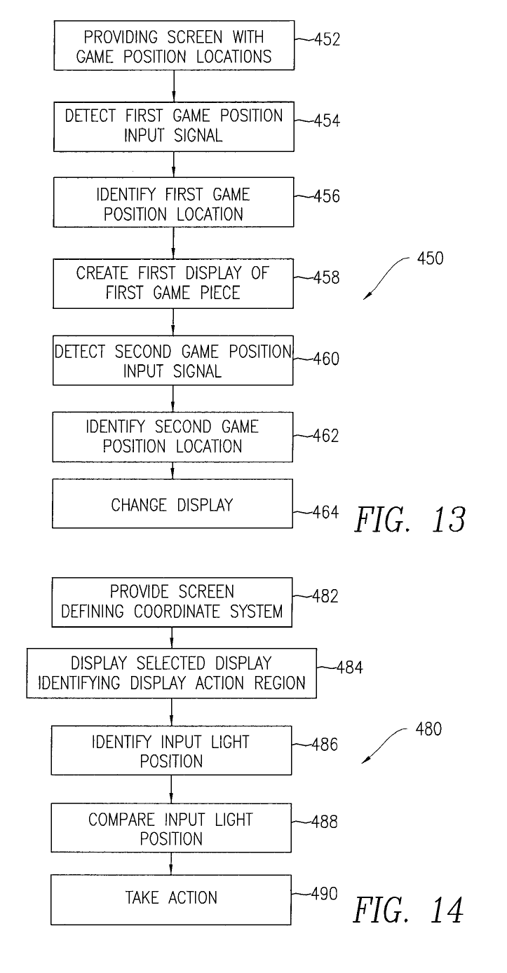

The light image creation mechanism of the present application may also be utilized in a method 450 of creating and manipulating an optical game image, illustrated by the flow diagram of FIG. 13 which may comprise the steps of providing a plurality of game position locations defined within a coordinate system having an origin represented by the Provide Screen with Game Position Locations block 452. The next step in the method 450 may be, utilizing a game position indication input signal detection unit moving with respect to the coordinate system, detecting a first game position indication input signal as indicated by the Detect First Game Position Input Signal block 454.

The method 450 may then identify a first game position location point within the coordinate system in response to the detection of the first game location position indication input signal represented by the Identify First Game Position Location block 458. The method 450 may then perform the step of, utilizing a light generation unit, moving with respect to the coordinate system, creating a first display of a first game piece at the first game position. This is represented by the Create First Display of the first Game Piece block 458.

It will be understood that these initial steps of the method 450 represented by the first part of FIG. 13 are the basic steps for each of the game playing utilizations for the light image creation mechanism 20 of the present application, i.e., tic-tac-toe, maze and action or the like board games, which could include checkers or chess games or the like in addition to the battle recreation game disclosed. Another possible game could be, similar to connect the flashing dots in a Dot-to-Dot mode, hitting the randomly presented targets, much like the popular whack-the-mole games.

A subsequent step in the method 450 of FIG. 13 may comprise, utilizing the light initiation position indication signal detection unit moving with respect to the map, identifying a second game location position input signal, represented by the Detect Second Game Position Input Signal step of block 460. This step may be followed by a step of identifying a second game position location within the coordinate system in response to the detection of the second game location position input signal, represented by the Identify Second Game Position Location block 462. This step may them be followed by a step of changing the display of the game piece at the first game position location to a display of the game piece at the second game position location responsive to the identification of the second game position input signal, one of a variety of Change Display steps represented in block 464.

It will be understood that any form of change in the display in response to the second game position identification from the input signal is fundamentally part of all of the above disclosed game playing methods utilizing the light image creation mechanism 20 of the present application. The particular ones recited here may only apply to some of the game playing methods disclosed above.

Another method of utilization of the light image creation mechanism of the present application could be the method 480 illustrated in FIG. 14. Such a method of creating an optical image may comprise providing a screen defining a coordinate system contained within the screen and having an origin, indicated by the Provide Screen Defining Coordinate System step of block 482. The next step may be, utilizing a light generation unit, moving with respect to the screen, displaying a selected display on the screen identifying a display action region on the screen comprising one or more light input positions on the screen. This is represented by the Display Selected Display Identifying Display Action Region step 484 and corresponds at least to the method or menu display generation discussed above. The next step could be, utilizing an input light indication signal detection unit, moving with respect to the screen, identifying a light input signal position within the coordinate system, the Identify Input Light Position step of block 486. Then the method 480 may perform a step of comparing the light signal position to the light input signal position or positions on the screen defining the display action region, which corresponds to the Compare Input Light Position step of block 488. Finally the method 480 may perform a step of taking action according to whether or not there is a match between the detected light input signal position and a light input signal position within the display action region, the Take Action Step of FIG. 14.

It will be understood that the embodiments described herein are merely exemplary and that a person skilled in the art may make many variations and modifications without departing from the spirit and scope of the invention. Some possible variations and modifications are noted above, but not all that would be appreciated by those skilled in the art are mentioned. All such variations and modifications, including those discussed above, are intended to be included within the scope of the invention as defined in the appended claims.

We claim:

1. An optical image creation mechanism comprising:
a screen defining a coordinate system oriented to the screen and having an origin on the screen;
a input signal detection unit, moving with respect to the screen, and comprising a light input signal position identifier identifying a light input signal position within the coordinate system;
a light generation unit, moving with respect to the screen, and comprising a light initiation mechanism initiating the display of light responsive to the light input signal position within the coordinate system.

2. The optical image creation mechanism of claim 1 further comprising:
the light generation unit displaying the light from the light input signal position within the coordinate system to a second light position within the coordinate system.

3. The optical image creation mechanism of claim 1 further comprising:
the input signal detection unit comprising a light input signal detector rotating about the origin of the coordinate system of the screen.

4. The optical image creation mechanism of claim 1 further comprising:
the light generation unit comprising a light emitter rotating about the origin of the coordinate system of the screen.

5. The optical image creation mechanism of claim 1 further comprising:
a controller controlling the light generation unit in response to the light input signal position within the coordinate system according to a stored controller program.

6. The optical image creation mechanism of claim 3 further comprising:
a controller controlling the light generation unit in response to the light input signal position within the coordinate system according to a stored controller program.

7. The optical image creation mechanism of claim 5 further comprising:
a controller controlling the display of the light in a selected pattern oriented to the light input signal position within the coordinate system.

8. The optical image creation mechanism of claim 6 further comprising:
a controller controlling the display of the light in a selected pattern oriented to the light input signal position within the coordinate system.

9. The optical image creation mechanism of claim 7 further comprising:
a controller controlling the display of light responsive to a subsequent light input signal identified by the light input signal detection unit.

10. The optical image creation mechanism of claim 8 further comprising:
a controller controlling the display of light responsive to a subsequent light input signal identified by the light input signal detection unit.

11. The optical image creation mechanism of claim 3 further comprising:
a controller controlling the display of light responsive to a subsequent light input signal identified by the light input signal detection unit.

12. The optical image creation mechanism of claim 3 further comprising:
the input signal detection unit comprising one of a plurality of light input signal detector elements positioned on a rotating blade on a first extension of the rotating blade;
the light generation unit comprising one of a plurality of light generator elements positioned on a second extension of the rotating blade.

13. The optical image creation mechanism of claim 12 further comprising:
the first extension extending from a rotational axis of the blade in a first direction and the second extension extending from the rotational axis of the blade in a second direction different from the first direction.

14. The optical image creation mechanism of claim 5 further comprising:
the input signal detection unit comprising one of a plurality of light input signal detector elements positioned on a rotating blade on a first extension of the rotating blade;
the light generation unit comprising one of a plurality of light generator elements positioned on a second extension of the rotating blade.

15. The optical image creation mechanism of claim 14 further comprising:
the first extension extending from a rotational axis of the blade in a first direction and the second extension extending from the rotational axis of the blade in a second direction different from the first direction.

16. A method of creating an optical image comprising:
providing a screen defining a coordinate system contained within the screen and having an origin;
utilizing an input signal detection unit, moving with respect to the screen, identifying a light input signal position within the coordinate system;
utilizing a light generation unit, moving with respect to the screen, initiating the display of a light responsive to the light input signal position within the coordinate system.

17. The method of claim 16 further comprising:
utilizing the light generation unit, displaying the light at a second position within the coordinate system defined by the movement of the light generation unit.

18. The method of claim 16 further comprising:
utilizing the light input signal detection unit, detecting an input signal with a detector rotating about the origin of the coordinate system of the screen.

19. The method of claim 16 further comprising:
utilizing the light generation unit, displaying a predetermined stored image selected based upon an identified light input signal.

20. The method of claim 17 further comprising:
utilizing the light generation unit, displaying a predetermined stored image selected based upon an identified light input signal.

21. A method of creating and manipulating an optical game image comprising:
providing a plurality of game position locations defined within a coordinate system having an origin;
utilizing a game position location input signal detection unit, moving with respect to the coordinate system, detecting a first game position location input signal;
identifying a first game position location within the coordinate system in response to the detection of the first game position location input signal;
utilizing a light generation unit, moving with respect to the coordinate system, creating a first display of a first game piece at the first game position location.

22. A method of creating and manipulating an optical game image comprising:
providing a plurality of game position locations defined within a coordinate system having an origin;
utilizing a game position location input signal detection unit, moving with respect to the coordinate system, detecting a first game position location input signal;
identifying a first game position location within the coordinate system in response to the detection of the first game position location input signal;
utilizing a light generation unit, moving with respect to the coordinate system, creating a first display of a first game piece at the first game position location;
utilizing the game position location input signal detection unit, moving with respect to the coordinate system, detecting a second game position location input signal;
identifying a second game position location within the coordinate system in response to the detection of the second game position location input signal;
changing the display of the game piece at the first game position location to a display of the game piece at the second game position location responsive to the identification of the second game position location input signal.

23. The method of claim 22 further comprising:
the display of the game piece at the second game position includes a modified orientation within the second game position location from the orientation of the game piece within the first game position location.

24. A method of creating an optical image comprising:
providing a screen defining a coordinate system contained within the screen and having an origin;
utilizing a light generation unit, moving with respect to the screen, displaying a selected display on the screen identifying a display action region on the screen comprising one or more light input signal positions on the screen;
utilizing an input signal detection unit, moving with respect to the screen, identifying a light input signal position within the coordinate system;
comparing the identified light input signal position to the light input signal position or positions on the screen defining the display action region;
taking action according to whether or not there is a match between the identified light input signal position and a light input signal position within the display action region.

25. A method of creating an optical image comprising:
providing an image position screen defining a coordinate system contained within the screen and having an origin;
detecting a first light input signal;
generating a menu image utilizing a stored image database, the first light input signal or a combination of the stored image database and the first light input signal to display an input menu on the screen;
utilizing a second light input signal, located by a relationship to the menu image, modifying the optical image.

26. The optical image creation mechanism of claim 5 further comprising:
a coordinate system orientation signal transmitter and a coordinate system orientation signal detector cooperative to provide to the controller a coordinate system orientation signal.

27. The optical image creation mechanism of claim 1 further comprising:
a mode of operation signal detector rotating about the origin of the coordinate system of the screen and adapted to receive a mode of operation input signal of a type determined by the rotational angular displacement of the mode of operation signal detector when the mode of operation signal is detected.
